(19) United States
(12) Patent Application Publication
(10) Pub. No.: US 2025/0012650 A1
(43) Pub. Date: Jan. 9, 2025

(54) TACTILE SENSOR UNIT, CONTACT SENSOR MODULE, AND ROBOT ARM UNIT

(71) Applicant: SONY GROUP CORPORATION, Tokyo (JP)

(72) Inventor: Akihiro NOMOTO, Tokyo (JP)

(73) Assignee: SONY GROUP CORPORATION, Tokyo (JP)

(21) Appl. No.: 18/710,300

(22) PCT Filed: Oct. 19, 2022
(86) PCT No.: PCT/JP2022/038954

§ 371 Date: May 15, 2024

(30) Foreign Application Priority Data
Dec. 2, 2021 (JP) 2021-196251

(51) Int. Cl. G01L 5/00; B25J 19/02; G01L 1/24

(52) U.S. Cl. CPC G01L 5/0061; B25J 19/021; G01L 1/24

(57) ABSTRACT

A tactile sensor unit according to one embodiment of the present disclosure includes: a compound-eye imaging unit in which a plurality of compound-eye imaging devices is two-dimensionally disposed on a flexible sheet; an illuminating unit that illuminates an imaging region of the compound-eye imaging unit; and a deformation layer in which a marker is formed in the imaging region.

### TECHNICAL FIELD

The present disclosure relates to a tactile sensor unit, a contact sensor module, and a robot arm unit.

### BACKGROUND ART

In order to control handling of an object by a robot, a large number of sensors are used in the robot. For example, PTL 1 below discloses the sensors to be used in the robot.

### CITATION LIST

### Patent Literature

PTL 1: International Publication No. WO2018/235214

### SUMMARY OF THE INVENTION

Incidentally, a sensor is required to be downsized to apply the sensor to a distal end portion of a robot arm. In particular, in a case where a vision-type contact sensor that uses a camera to measure surface displacement of the distal end portion of the robot arm is applied to the distal end portion of the robot arm, a device is increased in size by an amount corresponding to a focal length of the camera. Accordingly, it is desirable to provide a tactile sensor unit that allows downsizing to be achieved, and to provide a contact sensor module and a robot arm unit each including such a tactile sensor unit.

A tactile sensor unit according to a first embodiment of the present disclosure includes: a compound-eye imaging unit in which a plurality of compound-eye imaging devices is two-dimensionally disposed on a flexible sheet; an illuminating unit that illuminates an imaging region of the compound-eye imaging unit; and a deformation layer in which a marker is formed in the imaging region.

A tactile sensor unit according to a second embodiment of the present disclosure includes: a compound-eye imaging unit in which a plurality of compound-eye imaging devices is two-dimensionally disposed on a flexible sheet; and an elastic layer formed in an imaging region of the compound-eye imaging. This tactile sensor unit further includes: a mark-less screen layer provided inside of the elastic layer or on a surface of the elastic layer; and a projecting unit that projects a fixed pattern image as a marker onto the mark-less screen layer.

A tactile sensor module according to a third embodiment of the present invention includes a contact sensor unit and a signal processing unit. The contact sensor unit includes: a compound-eye imaging unit in which a plurality of compound-eye imaging devices is two-dimensionally disposed on a flexible sheet; an illuminating unit that illuminates an imaging region of the compound-eye imaging unit; and a deformation layer in which a marker is formed in the imaging region. The contact sensor unit further includes an output section that outputs a detection signal obtained from each of the compound-eye imaging devices as compound-eye image data to the signal processing unit. The signal processing unit is configured to generate surface shape data of the deformation layer by processing the compound-eye image data inputted from the contact sensor unit.

A tactile sensor module according to a fourth embodiment of the present invention includes a contact sensor unit and a signal processing unit. The contact sensor unit includes: a compound-eye imaging unit in which a plurality of compound-eye imaging devices is two-dimensionally disposed on a flexible sheet; and an elastic layer formed in an imaging region of the compound-eye imaging. The contact sensor unit further includes: a mark-less screen layer provided inside of the elastic layer or on a surface of the elastic layer; a projecting unit that projects a fixed pattern image as a marker onto the mark-less screen layer; and an output section that outputs a detection signal obtained from each of the compound-eye imaging devices as compound-eye image data to the signal processing unit. The signal processing unit is configured to generate surface shape data of the elastic layer by processing the compound-eye image data inputted from the contact sensor unit.

A robot arm unit according to a fifth embodiment of the present disclosure includes: a hand unit; an arm unit coupled to the hand unit, the arm unit including a wrist joint and an elbow joint; and a contact sensor unit mounted to a fingertip of the hand unit. The contact sensor unit includes: a compound-eye imaging unit in which a plurality of compound-eye imaging devices is two-dimensionally disposed on a flexible sheet; an illuminating unit that illuminates an imaging region of the compound-eye imaging unit; and a deformation layer in which a marker is formed in the imaging region.

A tactile sensor unit according to a sixth embodiment of the present disclosure includes: a hand unit; an arm unit coupled to the hand unit, the arm unit including a wrist joint and an elbow joint; and a contact sensor unit mounted to a fingertip of the hand unit. The contact sensor unit includes: a compound-eye imaging unit in which a plurality of compound-eye imaging devices is two-dimensionally disposed on a flexible sheet; and an elastic layer formed in an imaging region of the compound-eye imaging unit. This tactile sensor unit further includes: a mark-less screen layer provided inside of the elastic layer or on a surface of the elastic layer; and a projecting unit that projects a fixed pattern image as a marker onto the mark-less screen layer.

In the tactile sensor unit according to each of the first and second embodiments of the present disclosure, the tactile sensor module according to each of the third and fourth embodiments of the present disclosure, and the robot arm unit according to each of the fifth and sixth embodiments of the present disclosure, the plurality of compound-eye imaging devices is two-dimensionally disposed on the flexible sheet. This allows the tactile sensor unit to be mounted along the surface of the fingertip of the robot arm unit, and hence it is possible to avoid increasing the size of the fingertip of the robot arm unit due to the mounting of the tactile sensor unit.

### BRIEF DESCRIPTION OF DRAWING

FIG. 1 is a diagram illustrating an example of a cross-sectional configuration of a tactile sensor unit according to a first embodiment of the present disclosure.

FIG. 2 is a diagram illustrating an example of a planar configuration of the tactile sensor unit of FIG. 1.

FIG. 3 is a diagram illustrating a state in which the tactile sensor unit of FIG. 1 is installed on a surface of a robot finger portion.

FIG. 4 is a diagram illustrating a functional block example of the tactile sensor unit of FIG. 1.

FIG. 5 is a diagram illustrating an example of a cross-sectional configuration of a compound-eye imaging device of FIG. 1.

FIG. 6 is a diagram illustrating one modification example of the cross-sectional configuration of the compound-eye imaging device of FIG. 1.

FIG. 7 is a diagram illustrating one modification example of the cross-sectional configuration of the compound-eye imaging device of FIG. 1.

FIG. 8 is a diagram illustrating one modification example of the cross-sectional configuration of the compound-eye imaging device of FIG. 1.

FIG. 9 is a diagram illustrating one modification example of the cross-sectional configuration of the compound-eye imaging device of FIG. 1.

FIG. 10 is a diagram illustrating one modification example of the cross-sectional configuration of the compound-eye imaging device of FIG. 1.

FIG. 11 is a diagram illustrating an example of a cross-sectional configuration of a tactile sensor unit according to a second embodiment of the present disclosure.

FIG. 12 is a diagram illustrating an example of a planar configuration of the tactile sensor unit of FIG. 11.

FIG. 13 is a diagram illustrating an example of a cross-sectional configuration of a tactile sensor unit according to a third embodiment of the present disclosure.

FIG. 14 is a diagram illustrating an example of a planar configuration of the tactile sensor unit of FIG. 13.

FIG. 15 is a diagram illustrating one modification example of the cross-sectional configurations of the tactile sensor units of FIG. 1, FIG. 11, and FIG. 13.

FIG. 16 is a diagram illustrating one modification example of the cross-sectional configurations of the tactile sensor units of FIG. 1, FIG. 11, and FIG. 13.

FIG. 17 is a diagram illustrating one modification example of the cross-sectional configurations of the tactile sensor units of FIG. 1, FIG. 11, and FIG. 13.

FIG. 18 is a diagram illustrating one modification example of the cross-sectional configurations of the tactile sensor units of FIG. 1, FIG. 11, and FIG. 13.

FIG. 19 is a diagram illustrating an example of a cross-sectional configuration of a tactile sensor unit according to a fourth embodiment of the present disclosure.

FIG. 20 is a diagram illustrating an example of a planar configuration of the tactile sensor unit of FIG. 19.

FIG. 21 is a diagram illustrating one modification example of the cross-sectional configuration of the tactile sensor unit of FIG. 1.

FIG. 22 is a diagram illustrating an example of a planar configuration of the tactile sensor unit of FIG. 21.

FIG. 23 is a diagram illustrating an example of an external appearance of a robot apparatus in which the above-described tactile sensor unit is applied to a distal end portion of a robot arm unit.

FIG. 24 is a diagram illustrating a functional block example of the robot apparatus of FIG. 23.

### MODES FOR CARRYING OUT THE INVENTION

In the following, some embodiments of the present disclosure will be described in detail with reference to the drawings. The following description is one specific example of the present disclosure, and the present disclosure is not limited to the following embodiments. In addition, the arrangement, dimensions, dimension ratios, and the like of components illustrated in each drawing in the present disclosure are also not limited to those embodiments. It is to be noted that the description will be given in the following order.

### 1. First Embodiment (Tactile Sensor Unit)

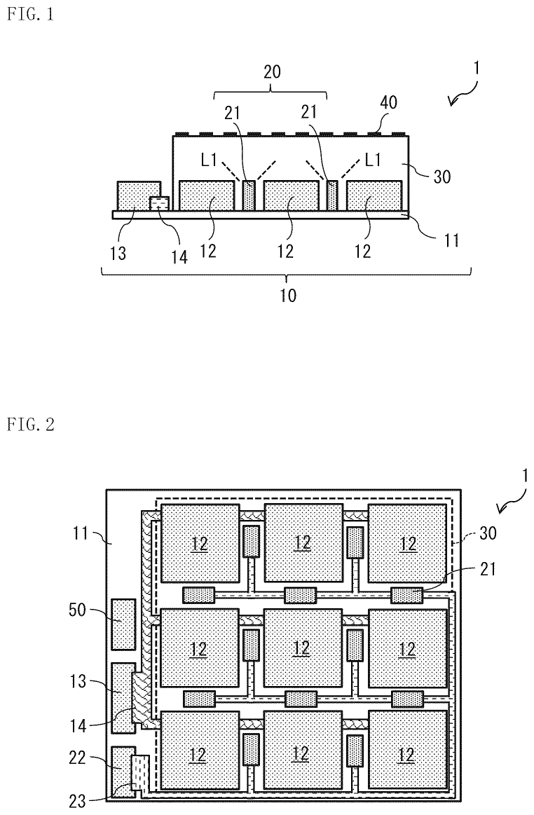

an example in which deformation of a marker is detected by a compound-eye imaging device (FIG. 1 to FIG. 5)

### 2. Modification Examples of First Embodiment (Tactile Sensor Unit)

Modification Examples A to E: variations of the compound-eye imaging device (FIG. 6 to FIG. 10)

### 3. Second Embodiment (Tactile Sensor Unit)

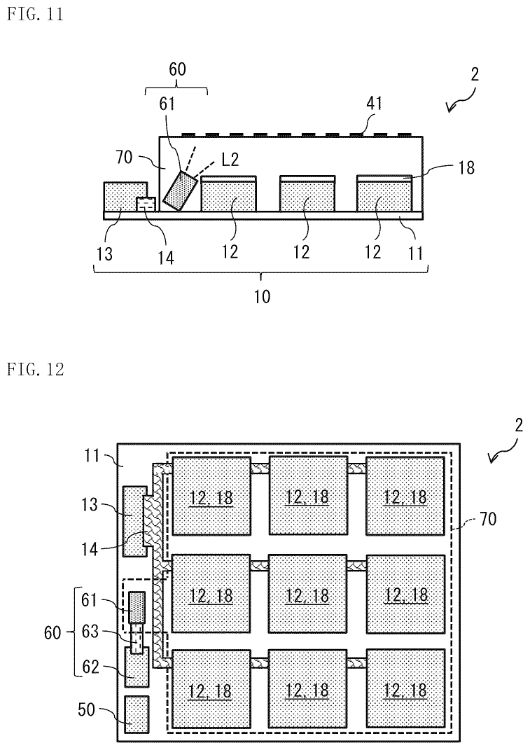

an example in which illumination light is caused to propagate through an elastic light guide layer (FIG. 11 and FIG. 12)

### 4. Third Embodiment (Tactile Sensor Unit)

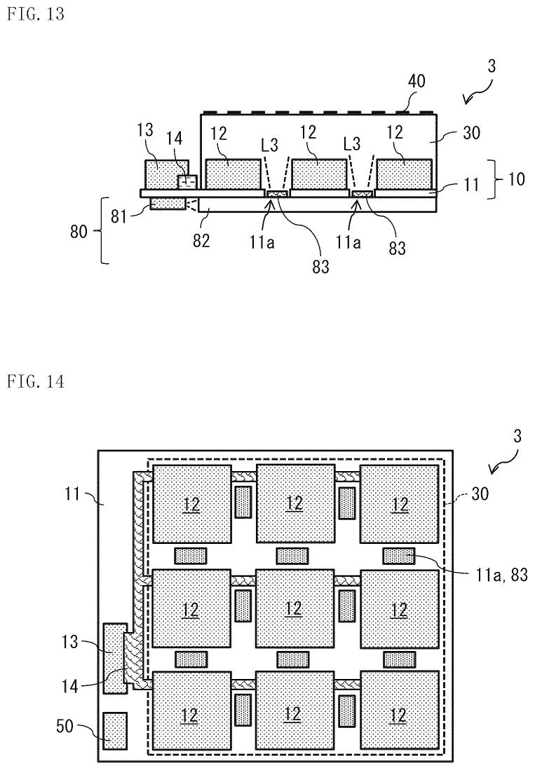

an example in which illumination light is caused to propagate through a flexible light guide layer (FIG. 13 and FIG. 14)

### 5. Modification Examples Common to Respective Embodiments (Tactile Sensor Unit)

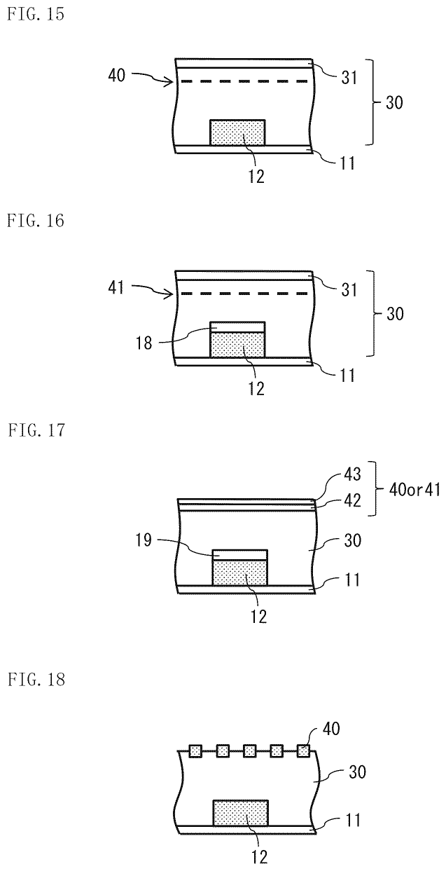

### Modification Example F: An Example in which a Marker Layer is Provided in an Elastic Layer (FIG. 15 and FIG. 16)

### Modification Example G: An Example in which a Plurality of Stacked Marker Layers is Provided (FIG. 17)

### Modification Example H: An Example in which a Surface of the Elastic Layer has Unevenness (FIG. 18)

### 6. Fourth Embodiment (Tactile Sensor Unit)

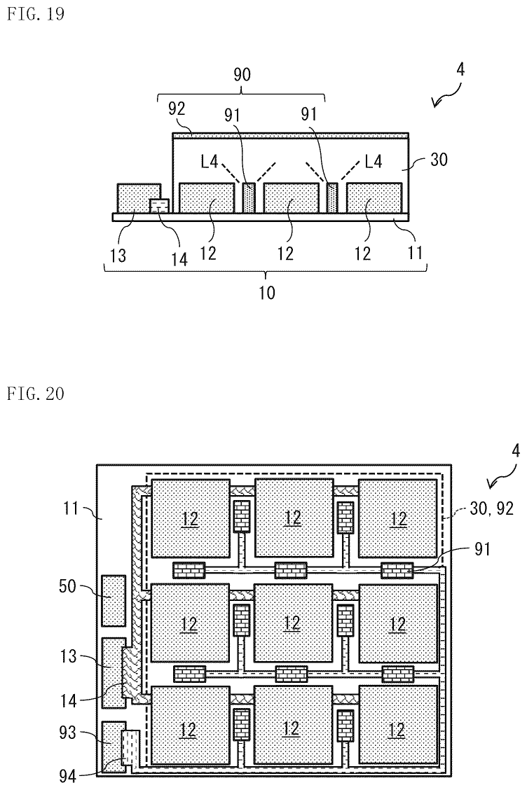

an example in which a structured light source is used (FIG. 19 and FIG. 20)

### 7. Modification Example of First Embodiment (Tactile Sensor Unit)

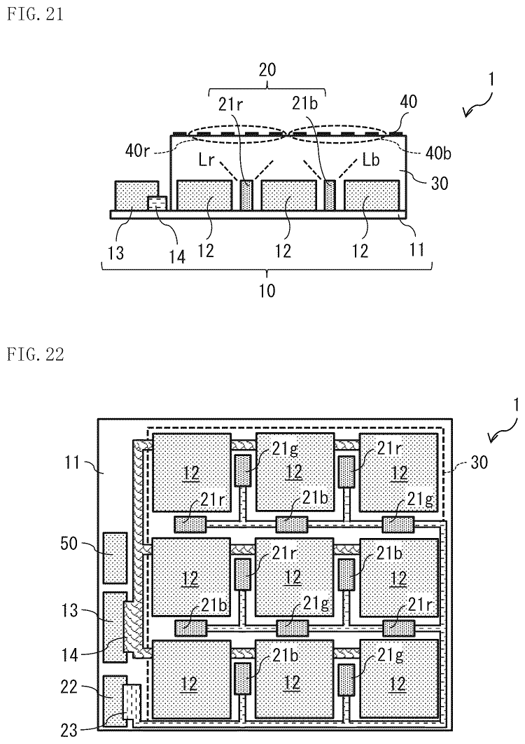

an example in which RGB light is used as the illumination light (FIG. 21 and FIG. 22)

### 8. Application Example (Robot Apparatus)

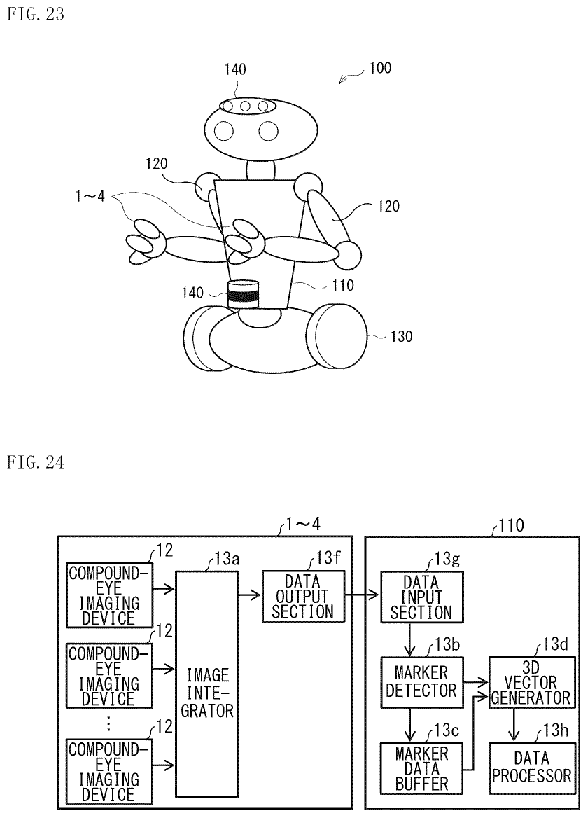

an example in which the tactile sensor unit is provided to a fingertip of a robot (FIG. 23 and FIG. 24)

### 1. With Regard to Compound Eye Camera

A compound eye camera is a camera in which a plurality of facet lenses is provided for one image sensor. Light collected by each of the plurality of facet lenses is received by the image sensor. An image signal obtained through photoelectric conversion in the image sensor is processed by a signal processing block on the downstream. In this manner, one image is generated on the basis of light beams respectively collected by the plurality of facet lenses.

A main feature of the compound eye camera resides in that it is possible to reduce a distance from a surface of a lens (facet lens) to the image sensor as compared with a monocular camera. Accordingly, in the compound eye camera, it is possible to reduce the thickness of the camera as compared with the monocular camera. Further, it is possible to extract information regarding a distance from the camera to an object by using parallax or the like obtained by the plurality of facets. Further, with the image obtained by the facets being subjected to signal processing on the basis of the structure of the compound eye camera, it is possible to obtain a resolution higher than that of the facets.

The applicant of the present disclosure proposes a thin tactile sensor unit in which a compound eye camera is applied as a sensor that detects surface displacement. Further, the applicant of the present disclosure proposes a tactile sensor unit in which a plurality of compound eye cameras is mounted on a flexible sheet to allow the tactile sensor unit to be installed on a curved surface.

It is to be noted that the compound eye camera is not limited to the above-described configuration. The compound eye camera may include, for example, a plurality of facet cameras that is two-dimensionally disposed. A facet camera is a camera in which one lens is provided for one image sensor. The compound eye camera may include, for example, a plurality of facet pixels that is two-dimensionally disposed. A facet pixel is a device in which one lens is provided for one photodiode.

### 2. First Embodiment

### (Configuration)

A tactile sensor unit 1 according to a first embodiment of the present disclosure is described. FIG. 1 illustrates an example of a cross-sectional configuration of the tactile sensor unit 1. FIG. 2 illustrates an example of a planar configuration of the tactile sensor unit 1. The tactile sensor unit 1 is a device that is suitably applicable as a sensor that detects contact of a distal end portion of a robot arm unit to an external object. The tactile sensor unit 1 includes, for example, as illustrated in FIG. 1 and FIG. 2, a compound-eye imaging unit 10, an illuminating unit 20, an elastic layer 30, a marker layer 40, and a controller 50.

### (Compound-Eye Imaging Unit 10)

The compound-eye imaging unit 10 includes, for example, as illustrated in FIG. 1 and FIG. 2, a flexible sheet 11 and a plurality of compound-eye imaging devices 12. The plurality of compound-eye imaging devices 12 is two-dimensionally disposed on the flexible sheet 11. The compound-eye imaging unit 10 further includes, for example, as illustrated in FIG. 1 and FIG. 2, a signal processor 13 and a flexible printed circuit (FPC) 14 that electrically couples each of the plurality of compound-eye imaging devices 12 and the signal processor 13 to each other. For example, as illustrated in FIG. 2, the signal processor 13 and the FPC 14 are disposed on the flexible sheet 11.

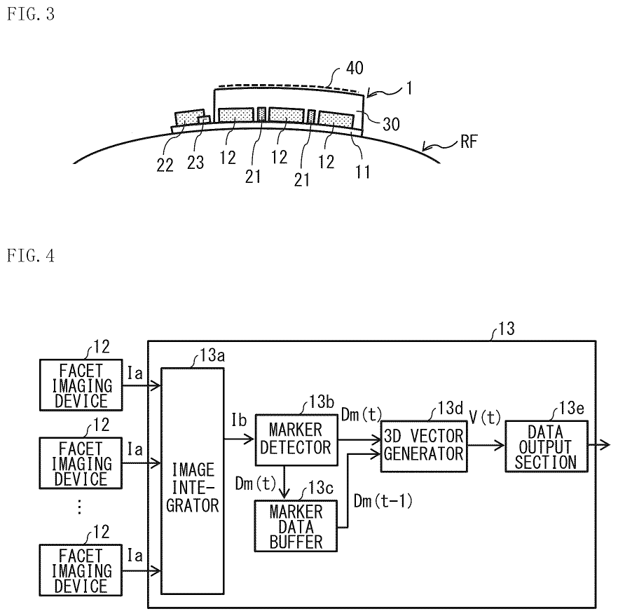

The flexible sheet 11 is, for example, as illustrated in FIG. 3, a sheet having a high flexibility, which is to be bonded along a surface of a fingertip (robot finger portion RF) of a robot arm. The flexible sheet 11 includes, for example, a flexible resin sheet. Examples of a material of such a resin sheet include polyimide and PET.

Each compound-eye imaging device 12 images an imaging region to output a detection signal obtained from each pixel as compound-eye image data Ia to the signal processor 13. For example, each compound-eye imaging device 12 performs imaging for each predetermined period in accordance with control by the controller 50, and outputs the compound-eye image data Ia thus obtained to the signal processor 13 via the FPC 14. Each compound-eye imaging device 12 includes one or a plurality of microlenses, and one or a plurality of optical sensors provided to correspond to the one or the plurality of microlenses. The configuration of each compound-eye imaging device 12 is described in detail later.

The signal processor 13 generates integrated compound-eye image data Ib by combining a plurality of pieces of compound-eye image data Ia obtained at the same time from the plurality of compound-eye imaging devices 12. The signal processor 13 further generates, from each piece of compound-eye image data Ia, parallax data Dp about the depth. The parallax data Dp corresponds to surface shape data of the elastic layer 30. The signal processor 13 derives a displacement amount within a plane of a marker position in one period, on the basis of the integrated compound-eye image data Ib at a time t and the integrated compound-eye image data Ib at a time t−1 that is one period before the time t. The signal processor 13 further derives a displacement amount in a depth direction of the marker position in one period, on the basis of the parallax data Dp at the time t and the parallax data Dp at the time t−1. That is, the signal processor 13 derives a displacement amount in a three-dimensional direction of the marker position, on the basis of the plurality of pieces of compound-eye image data Ia obtained from the plurality of compound-eye imaging devices 12. The signal processor 13 outputs the derived displacement amount to an external apparatus. The signal processor 13 may generate pressure vector data about a pressure applied to the elastic layer 30, on the basis of the displacement amount in the three-dimensional direction of the marker position and physical property information of the elastic layer 30. In this case, the signal processor 13 outputs the generated pressure vector data to the external apparatus.

### (Illuminating Unit 20)

The illuminating unit 20 illuminates an imaging region of the compound-eye imaging unit 10. The illuminating unit 20 includes, for example, as illustrated in FIG. 1 and FIG. 2, a plurality of light emitting devices 21. For example, each of the plurality of light emitting devices 21 is disposed on the flexible sheet 11 and between corresponding two compound-eye imaging devices 12 adjacent to each other. Each light emitting device 21 emits, for example, light in a visible range toward the imaging region of the compound-eye imaging unit 10. Each light emitting device 21 is, for example, a light emitting diode that emits white light. The illuminating unit 20 further includes, for example, as illustrated in FIG. 2, a driver 22 that drives each light emitting device 21, and an FPC 23 that electrically couples each of the plurality of light emitting devices 21 and the driver 22 to each other. For example, as illustrated in FIG. 2, the driver 22 and the FPC 23 are disposed on the flexible sheet 11. The driver 22 drives each light emitting device 21 via the FPC 23.

### (Elastic Layer 30)

The elastic layer 30 is a layer that supports the marker layer 40 and also deforms when being pressed by an object from the outside. The deformation of the elastic layer 30 changes a position and a shape of the marker layer 40. For example, as illustrated in FIG. 1 and FIG. 2, the elastic layer 30 is disposed on the flexible sheet 11, and covers the plurality of compound-eye imaging devices 12 and the plurality of light emitting devices 21. The elastic layer 30 is, for example, a transparent silicone rubber layer having a thickness of about several millimeters. The term “transparent” as used herein refers to a state of having a light transmitting characteristic with respect to at least light emitted from the illuminating unit 20. A white silicone rubber layer is formed by, for example, adding a white pigment to transparent silicone rubber.

### (Marker Layer 40)

The marker layer 40 is formed in the imaging region of the compound-eye imaging unit 10. The marker layer 40 is, for example, disposed on the surface or inside of the elastic layer 30. FIG. 1 illustrates an example in which the marker layer 40 is disposed on the surface of the elastic layer 30. A complex including the elastic layer 30 and the marker layer 40 corresponds to one specific example of a “deformation layer” of the present disclosure. The marker layer 40 is, for example, a layer having a thickness of about several millimeters, which includes a mixture of silicone rubber and a pigment (for example, white pigment) that efficiently reflects the light of the illuminating unit 20. The marker layer 40 is formed by, for example, printing ink containing the above-described mixture onto the surface of the elastic layer 30. The marker layer 40 has, for example, a polka-dot pattern in plan view.

### (Controller 50)

The controller 50 controls the compound-eye imaging unit 10 and the illuminating unit 20 on the basis of a control signal supplied from outside. For example, the controller 50 causes the illuminating unit 20 to emit light at predetermined timing. For example, the controller 50 causes the compound-eye imaging unit 10 to detect, for each predetermined period, image light formed by the marker layer 40 reflecting the light of the illuminating unit 20, and to output data thus obtained by the compound-eye imaging unit 10 to the outside from the compound-eye imaging unit 10.

Next, functions of the signal processor 13 are described.

FIG. 4 illustrates a functional block example of the signal processor 13. The signal processor 13 includes, for example, as illustrated in FIG. 4, an image integrator 13a, a marker detector 13b, a marker data buffer 13c, a 3D vector generator 13d, and a data output section 13e.

The image integrator 13a integrates pieces of compound-eye image data Ia generated by the respective compound-eye imaging devices 12 in each predetermined period to generate the integrated compound-eye image data Ib. That is, the integrated compound-eye image data Ib is obtained by integrating a plurality of pieces of compound-eye image data Ia obtained at a predetermined time t. The integrated compound-eye image data Ib is generated by using, for example, arrangement information regarding the compound-eye imaging devices 12, arrangement information regarding each pixel in each compound-eye imaging device 12, characteristic information regarding each compound-eye imaging device 12, an imaging time, or other types of information. For example, the image integrator 13a may remove noise included in the compound-eye image data Ia obtained from each compound-eye imaging device 12, or calculate a predetermined feature amount on the basis of the compound-eye image data Ia obtained from each compound-eye imaging device 12. The image integrator 13a generates the parallax data Dp about the depth from each piece of compound-eye image data Ia. The image integrator 13a performs AD conversion of the generated integrated compound-eye image data Ib to generate digital integrated compound-eye image data Ib, and outputs the generated digital integrated compound-eye image data Ib to the marker detector 13b. The image integrator 13a further performs AD conversion of the generated parallax data Dp to generate digital parallax data Dp, and outputs the generated digital parallax data Dp to the marker detector 13b.

The marker detector 13b detects a position of the marker layer 40 on the basis of the integrated compound-eye image data Ib and the parallax data Dp inputted from the image integrator 13a. The marker detector 13b stores information regarding the detected position of the marker layer 40 (hereinafter referred to as “marker position information Dm(t)”) into the marker data buffer 13c, and outputs this information to the 3D vector generator 13d. The marker position information Dm(t) includes three-dimensional position information of the marker layer 40 at the time t. The marker data buffer 13c includes, for example, a non-volatile memory. The marker data buffer 13c store, for example, the marker position information Dm(t) at the time t and marker position information Dm(t−1) at a time t−1 that is one period before the time t.

The 3D vector generator 13d derives a change amount in a three-dimensional direction (hereinafter referred to as “3D vector V(t)”) of the marker position in one period, on the basis of the marker position information Dm(t) inputted from the marker detector 13b and the marker position information Dm(t−1) at the time t−1 read out from the marker data buffer 13c. The 3D vector generator 13d outputs the derived 3D vector V(t) to the data output section 13e. The data output section 13e outputs the 3D vector V(t) to an external apparatus.

Next, the configuration of the compound-eye imaging device 12 is described.

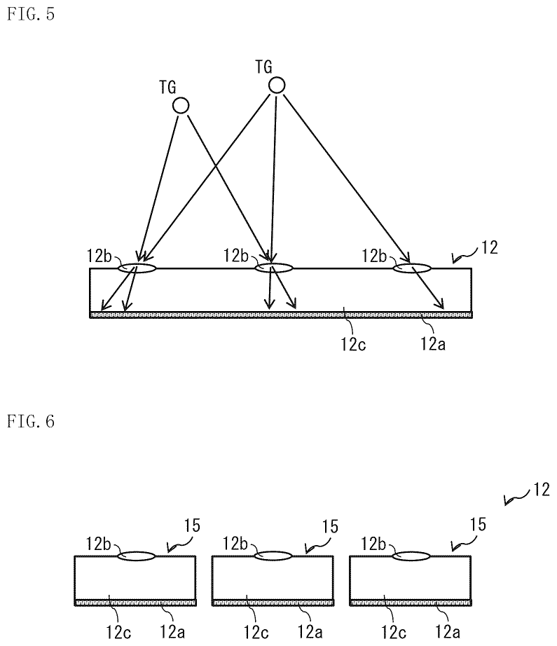

FIG. 5 illustrates an example of a cross-sectional configuration of the compound-eye imaging device 12. The compound-eye imaging device 12 includes, for example, as illustrated in FIG. 5, an imaging portion 12a, a plurality of microlenses 12b, and a light transmitting portion 12c that supports the plurality of microlenses 12b.

The imaging portion 12a is provided to correspond to the plurality of microlenses 12b. The imaging portion 12a includes a plurality of optical sensors (photodiodes), and includes, for example, a charge coupled device (CCD) image sensor or a complementary metal oxide semiconductor (CMOS) image sensor. For example, the imaging portion 12a receives reflected light (image light) reflected from the marker layer 40 in accordance with a control signal supplied from the controller 50, and outputs a detection signal thus obtained from each pixel as the compound-eye image data Ia to the signal processor 13.

The plurality of microlenses 12b is disposed to be opposed to the imaging portion 12a with a predetermined gap provided therebetween, and forms an image of the reflected light (image light) reflected from the marker layer 40 on a light receiving surface of the imaging portion 12a. For example, as illustrated in FIG. 5, the plurality of microlenses 12b is disposed in such a manner that parts of viewing ranges of at least two microlenses 12b (for example, targets TG in the figure) overlap each other. In the imaging portion 12a, the plurality of microlenses 12b is disposed in one line or is two-dimensionally disposed. The light transmitting portion 12c is disposed between the plurality of microlenses 12b and the imaging portion 12a. The light transmitting portion 12c includes, for example, transparent silicone rubber.

### (Effects)

Next, effects of the tactile sensor unit 1 are described.

In this embodiment, the plurality of compound-eye imaging devices 12 is two-dimensionally disposed on the flexible sheet 11. This allows the thickness of each compound-eye imaging device 12 to be reduced. Further, it is possible to mount the tactile sensor unit 1 along the surface of the robot finger portion RE. Accordingly, it is possible to avoid increasing the size of the robot finger portion RF due to the mounting of the tactile sensor unit 1.

In this embodiment, each compound-eye imaging device 12 is a compound eye camera including the plurality of microlenses 12b and the imaging portion 12a provided to correspond to the plurality of microlenses 12b. This allows the thickness of each compound-eye imaging device 12 to be reduced. Accordingly, it is possible to avoid increasing the size of the robot finger portion RF due to the mounting of the tactile sensor unit 1.

In this embodiment, each of the plurality of light emitting devices 21 is disposed on the flexible sheet 11 and between corresponding two compound-eye imaging devices 12 adjacent to each other. This allows light emitted from each light emitting device 21 to be applied to the marker layer 40 while preventing the light emitted from each light emitting device 21 from directly entering the compound-eye imaging device 12. Further, the plurality of light emitting devices 21 is disposed on the flexible sheet 11, and hence it is possible to avoid increasing the thickness of the tactile sensor unit 1 due to the provision of the plurality of light emitting devices 21.

### 3. Modification Examples of First Embodiment

Next, modification examples of the tactile sensor unit 1 according to the first embodiment are described.

### Modification Example A

FIG. 6 illustrates one modification example of the cross-sectional configuration of the compound-eye imaging device 12. In the above-described embodiment, each compound-eye imaging device 12 has been a compound eye camera in which one imaging portion 12a is provided for the plurality of microlenses 12b. However, in the above-described embodiment, each compound-eye imaging device 12 may include, for example, as illustrated in FIG. 6, a plurality of facet imaging devices 15 (facet cameras) in each of which one imaging portion 12a is provided for one microlens 12b.

At this time, in each compound-eye imaging device 12, the plurality of facet imaging devices 15 is disposed in one line or is two-dimensionally disposed. In such a case, each compound-eye imaging device 12 is bendable, and hence it is possible to mount the tactile sensor unit 1 even on a surface having a large curvature. As a result, it is possible to avoid increasing the size of the robot finger portion RF due to the mounting of the tactile sensor unit 1.

### Modification Example B

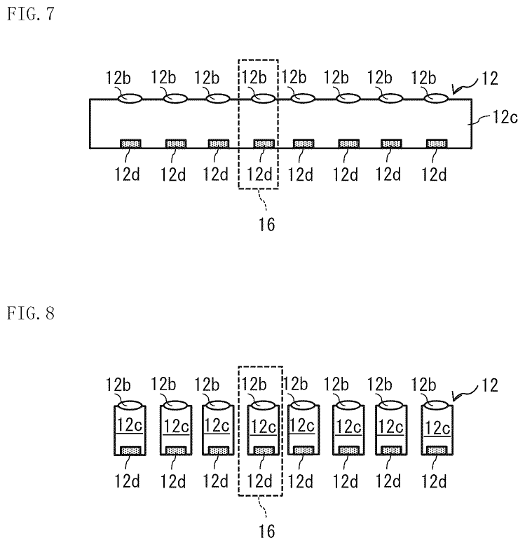

FIG. 7 illustrates one modification example of the cross-sectional configuration of the compound-eye imaging device 12. In the above-described embodiment, each compound-eye imaging device 12 may include, for example, as illustrated in FIG. 7, a plurality of facet imaging devices 16.

Each facet imaging device 16 includes, for example, as illustrated in FIG. 7, a light receiving element 12d, a microlens 12b, and a light transmitting portion 12c that supports the microlens 12b. The light receiving element 12d is a photodiode. The microlens 12b is disposed to be opposed to the light receiving element 12d with a predetermined gap provided therebetween, and forms an image of reflected light (image light) reflected from the marker layer 40 on a light receiving surface of the light receiving element 12d. The light transmitting portion 12c includes, for example, transparent silicone rubber. In each compound-eye imaging device 12, for example, the plurality of microlenses 12b is disposed in such a manner that parts of viewing ranges of at least two microlenses 12b overlap each other. In each compound-eye imaging device 12, the plurality of facet imaging devices 16 shares the light transmitting portion 12c, and is integrally formed.

In this modification example, the plurality of compound-eye imaging devices 12 is two-dimensionally disposed on the flexible sheet 11. This allows the thickness of each compound-eye imaging device 12 to be reduced as compared with a monocular imaging device. Moreover, it is possible to mount the tactile sensor unit 1 along the surface of the robot finger portion RF. Accordingly, it is possible to avoid increasing the size of the robot finger portion RF due to the mounting of the tactile sensor unit 1.

In this modification example, each compound-eye imaging device 12 includes a plurality of facet imaging devices 16 (facet cameras) each including one microlens 12b and the light receiving element 12d provided to correspond to the one microlens 12b. This allows the thickness of each compound-eye imaging device 12 to be reduced. Accordingly, it is possible to avoid increasing the size of the robot finger portion RF due to the mounting of the tactile sensor unit 1.

### Modification Example C

FIG. 8 illustrates one modification example of the cross-sectional configuration of the compound-eye imaging device 12. In Modification Example B described above, in each compound-eye imaging device 12, the plurality of facet imaging devices 16 has shared the light transmitting portion 12c, and has been integrally formed. However, in Modification Example B described above, for example, as illustrated in FIG. 8, the plurality of compound-eye imaging devices 12 may be formed independently of each other. In such a case, each compound-eye imaging device 12 is bendable, and hence it is possible to mount the tactile sensor unit 1 even on a surface having a large curvature. As a result, it is possible to avoid increasing the size of the robot finger portion RF due to the mounting of the tactile sensor unit 1.

### Modification Example D

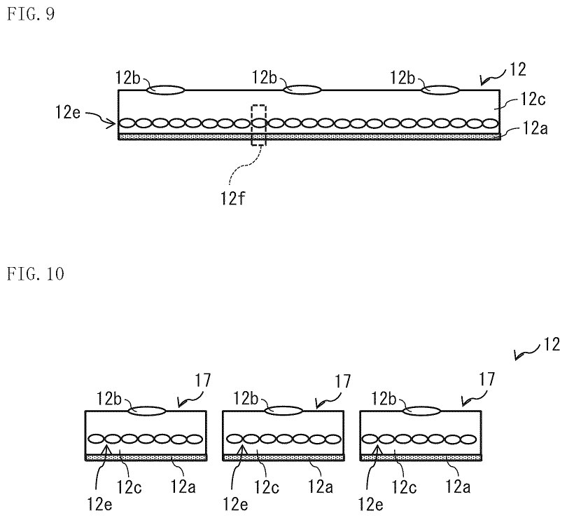

FIG. 9 illustrates one modification example of the cross-sectional configuration of the compound-eye imaging device 12. In the above-described embodiment, each compound-eye imaging device 12 may include, for example, as illustrated in FIG. 9, a microlens array 12e in the light transmitting portion 12c. Each microlens included in the microlens array 12e has a size smaller than the size of the microlens 12b, and a plurality of microlenses included in the microlens array 12e is allocated to one microlens 12b. Accordingly, in this modification example, each compound-eye imaging device 12 includes, for example, as illustrated in FIG. 9, a plurality of facet pixels 12f (sub-pixels) each including one microlens included in the microlens array 12e and a region of the imaging portion 12a opposed to this microlens. With the microlens array 12e being provided as described above, it is possible to perform pupil correction for each facet pixel 12f (sub-pixel) to correct a shading characteristic in the facet pixel 12f (sub-pixel), and thus correct a shading characteristic of the entire image. Further, it is also possible to increase a signal to noise ratio (S/N) of an outer edge portion of the entire image.

### Modification Example E

FIG. 10 illustrates one modification example of the cross-sectional configuration of the compound-eye imaging device 12. In Modification Example D described above, for example, as illustrated in FIG. 10, a plurality of microlenses included in the microlens array 12e may be separated for each corresponding microlens 12b. At this time, it is possible to say that each compound-eye imaging device 12 includes a plurality of facet imaging devices 17 each including one microlens 12b, a portion of the microlens array 12e, a portion of the imaging portion 12a, and a portion of the light transmitting portion 12c. The plurality of facet imaging devices 17 is formed independently of each other. This allows the tactile sensor unit 1 to be mounted along the surface of the robot finger portion RF more easily as compared with Modification Example D described above. As a result, it is possible to avoid increasing the size of the robot finger portion RF due to the mounting of the tactile sensor unit 1.

### 3. Second Embodiment

### (Configuration)

A tactile sensor unit 2 according to a second embodiment of the present disclosure is described. FIG. 11 illustrates an example of a cross-sectional configuration of the tactile sensor unit 2. FIG. 12 illustrates an example of a planar configuration of the tactile sensor unit 2. The tactile sensor unit 2 is a device that is suitably applicable as a sensor that detects contact of a distal end portion of a robot arm unit to an external object. The tactile sensor unit 2 includes, for example, as illustrated in FIG. 11 and FIG. 12, a compound-eye imaging unit 10, an illuminating unit 60, an elastic light guide layer 70, a marker layer 41, and a controller 50.

### (Marker Layer 41)

The marker layer 41 is formed in an imaging region of the compound-eye imaging unit 10. For example, the marker layer 41 is disposed on a surface or inside of the elastic light guide layer 70. FIG. 11 illustrates an example in which the marker layer 41 is disposed on the surface of the elastic light guide layer 70. A complex including the elastic light guide layer 70 and the marker layer 41 corresponds to one specific example of the “deformation layer” of the present disclosure. The marker layer 41 is, for example, a layer having a thickness of about several millimeters, which includes a mixture of a fluorescent material and silicone rubber. The marker layer 41 is formed by, for example, printing ink containing the above-described mixture onto the surface of the elastic light guide layer 70. The marker layer 41 has, for example, a polka-dot pattern in plan view.

### (Illuminating Unit 60)

The illuminating unit 60 illuminates the imaging region of the compound-eye imaging unit 10. The illuminating unit 60 includes, for example, as illustrated in FIG. 11 and FIG. 12, a light emitting device 61. For example, the light emitting device 61 is disposed on the flexible sheet 11 and near a region in which the plurality of compound-eye imaging devices 12 is disposed. The light emitting device 61 emits excitation light that excites the fluorescent material included in the marker layer 41. The light emitting device 61 causes the excitation light emitted from the light emitting device 61 to propagate through the elastic light guide layer 70 to illuminate the imaging region of the compound-eye imaging unit 10. Each light emitting device 61 is, for example, a light emitting diode that emits the above-described excitation light. The illuminating unit 60 further includes, for example, as illustrated in FIG. 12, a driver 62 that drives the light emitting device 61, and an FPC 63 that electrically couples the light emitting device 61 and the driver 62 to each other. For example, as illustrated in FIG. 12, the driver 62 and the FPC 63 are disposed on the flexible sheet 11. The driver 62 drives the light emitting device 61 via the FPC 63.

### (Compound-Eye Imaging Unit 10)

The compound-eye imaging unit 10 includes, for example, as illustrated in FIG. 11, a filter layer 18 that covers a light receiving surface of each compound-eye imaging device 12. The filter layer 18 is a wavelength selection filter that cuts the above-described excitation light and selectively transmits fluorescent light emitted from the marker layer 41. With the filter layer 18 being provided on the light receiving surface of each compound-eye imaging device 12, each compound-eye imaging device 12 can generate the compound-eye image data Ia on the basis of the fluorescent light transmitted through the filter layer 18.

### (Elastic Light Guide Layer 70)

The elastic light guide layer 70 is a flexible layer that supports the marker layer 41 and also deforms when being pressed by an object from the outside. The deformation of the elastic light guide layer 70 changes a position and a shape of the marker layer 41. The elastic light guide layer 70 further has a function of guiding the excitation light emitted from the light emitting device 61. For example, as illustrated in FIG. 11 and FIG. 12, the elastic light guide layer 70 is disposed on the flexible sheet 11, and covers the plurality of compound-eye imaging devices 12 and the light emitting device 61. The elastic light guide layer 70 is, for example, a transparent silicone rubber layer having a thickness of about several millimeters.

### (Controller 50)

The controller 50 controls the compound-eye imaging unit 10 and the illuminating unit 60 on the basis of a control signal supplied from the outside. For example, the controller 50 causes the illuminating unit 60 to emit light at predetermined timing. For example, the controller 50 causes the compound-eye imaging unit 10 to detect, for each predetermined period, image light formed by the marker layer 41 absorbing the light of the illuminating unit 60 and emitting excited light, and to output data thus obtained by the compound-eye imaging unit 10 to the outside from the compound-eye imaging unit 10.

### (Effects)

In this embodiment, the compound-eye image data Ia is generated on the basis of the fluorescent light emitted from the fluorescent material included in the marker layer 41. For example, it is assumed that blue excitation light emitted from the light emitting device 61 causes the marker layer 41 to emit red fluorescent light. At this time, the filter layer 18 cuts the blue excitation light and transmits the red fluorescent light. In this manner, the blue excitation light does not enter the compound-eye imaging device 12 (optical sensor), but the red fluorescent light only enters the compound-eye imaging device 12 (optical sensor). Thus, as compared with the case where the compound-eye image data Ia is generated on the basis of the reflected light reflected by the marker layer 41, it is possible to obtain compound-eye image data Ia having less noise. As a result, it is possible to increase a position accuracy of the marker.

### 4. Third Embodiment

### (Configuration)

A tactile sensor unit 3 according to a third embodiment of the present disclosure is described. FIG. 13 illustrates an example of a cross-sectional configuration of the tactile sensor unit 3. FIG. 14 illustrates an example of a planar configuration of the tactile sensor unit 3. The tactile sensor unit 3 is a device that is suitably applicable as a sensor that detects contact of a distal end portion of a robot arm unit to an external object. The tactile sensor unit 3 includes, for example, as illustrated in FIG. 13 and FIG. 14, a compound-eye imaging unit 10, an illuminating unit 80, an elastic layer 30, a marker layer 40, and a controller 50.

The tactile sensor unit 3 corresponds to a unit in which, in the tactile sensor unit 1 according to the above-described first embodiment, the illuminating unit 80 is provided in place of the illuminating unit 20. The illuminating unit 80 illuminates an imaging region of the compound-eye imaging unit 10. The illuminating unit 80 includes, for example, as illustrated in FIG. 13 and FIG. 14, a light emitting device 81, a flexible light guide layer 82, scattering layers 83, a driver 22, and an FPC 23.

For example, the light emitting device 81 is disposed on a back surface of the flexible sheet 11 (surface on a side opposite to a front surface on the compound-eye imaging device 12 side) and near a region opposed to the plurality of compound-eye imaging devices 12. For example, the light emitting device 81 emits light in a visible range toward an end surface of the flexible light guide layer 82. The light emitting device 81 is, for example, a light emitting diode that emits white light.

The flexible light guide layer 82 is a resin sheet having a high flexibility, which allows light in the visible range emitted from the light emitting device 81 to propagate therethrough. Examples of a material of such a resin sheet include silicone, acryl, polycarbonate, and cycloolefin. The flexible sheet 11 has a plurality of opening portions 11a provided therein. Each of the plurality of opening portions 11a is provided at a portion opposed to a region between corresponding two compound-eye imaging devices 12 adjacent to each other. On the front surface of the flexible light guide layer 82 (surface on the flexible sheet 11 side), a plurality of scattering layers 83 is provided in contact therewith. Each of the plurality of scattering layers 83 is provided in contact with a region of the front surface of the flexible light guide layer 82, which is exposed from a bottom surface of each opening portion 11a.

### (Effects)

In this embodiment, light of the light emitting device 81 that has propagated through the flexible light guide layer 82 is scattered by the scattering layer 83. In this manner, the scattering layer 83 becomes a light source to emit the light in the visible range toward the imaging region of the compound-eye imaging unit 10. In such a case, there is no need to provide the light emitting device 21 in the gap between the two compound-eye imaging devices 12 adjacent to each other, and hence it is possible to set the size of the gap between the two compound-eye imaging devices 12 adjacent to each other without being restricted by the light emitting device 21. It is to be noted that the occupying area of the scattering layer 83 is sufficiently smaller than that of the light emitting device 21, and it is thus possible to set the planar shape of the scattering layer 83 more freely as compared with the light emitting device 21. Accordingly, the scattering layer 83 does not become a restriction at the time of setting the size of the gap between the two compound-eye imaging devices 12 adjacent to each other. Further, it is possible to omit wiring for causing a current to flow through the light emitting device 21, which is required in a case where the light emitting device 21 is provided as the above-described first embodiment, and hence it is possible to form the tactile sensor unit 3 in simple structure.

### 5. Modification Examples Common to Respective Embodiments

Next, modification examples of the tactile sensor units 1 according to the first to third embodiments and the modification examples thereof are described.

### Modification Example F

In the above-described embodiments, for example, as illustrated in FIG. 15 and FIG. 16, the marker layer 40 or 41 may be provided inside of the elastic layer 30. At this time, for example, as illustrated in FIG. 15 and FIG. 16, on the surface of the elastic layer 30, a cover layer 31 having a relatively high wear resistance as compared with other portions of the elastic layer 30 may be provided. With the cover layer 31 being provided as described above, it is also possible to prevent the surface of the elastic layer 30 from being deteriorated. Further, in a case where the cover layer 31 is formed of a material having a relatively high hardness as compared with other portions of the elastic layer 30 (that is, in a case where the elastic layer 30 has a flexibility that is partially different), it is possible to transmit the deformation on the surface of the elastic layer 30 at high responsiveness to the marker layer 40 or 41.

### Modification Example G

In the above-described embodiments, the marker layer 40 or 41 may be a stacked member obtained by stacking a plurality of marker layers. At this time, the marker layer 40 or 41 may be, for example, as illustrated in FIG. 17, a stacked member obtained by stacking a first marker layer 42 and a second marker layer 43 in the stated order on the surface of the elastic layer 30.

The first marker layer 42 is in contact with the surface of the elastic layer 30. The second marker layer 43 is in contact with the surface of the first marker layer 42. The first marker layer 42 is disposed closer to each compound-eye imaging device 12 as compared with the second marker layer 43, and the second marker layer 43 is disposed more apart from each compound-eye imaging device 12 as compared with the first marker layer 42. As described above, the first marker layer 42 and the second marker layer 43 have a difference in depth as viewed from each compound-eye imaging device 12. This makes it possible to enhance sensitivity of surface deformation of the elastic layer 30.

In this modification example, the second marker layer 43 may be a layer having a relatively high flexibility as compared with other portions of the elastic layer 30, and the first marker layer 42 may be a layer having a relatively low flexibility as compared with the second marker layer 43. With the marker layer 40 or 41 including a plurality of layers having flexibilities different from each other as described above, it is possible to enhance the sensitivity of the surface deformation of the elastic layer 30.

### Modification Example H

In the above-described embodiments, for example, as illustrated in FIG. 18, the marker layer 40 may be formed on the surface of the elastic layer 30 so that a surface of a complex including the elastic layer 30 and the marker layer 40 has unevenness. At this time, the marker layer 40 may include a material having a relatively high hardness as compared with the elastic layer 30. This allows the sensitivity of the surface deformation of the elastic layer 30 to be enhanced as compared with a case where the surface of the complex including the elastic layer 30 and the marker layer 40 is a smooth surface.

### 6. Fourth Embodiment

### (Configuration)

A tactile sensor unit 4 according to a fourth embodiment of the present disclosure is described. FIG. 19 illustrates an example of a cross-sectional configuration of the tactile sensor unit 4. FIG. 20 illustrates an example of a planar configuration of the tactile sensor unit 4. The tactile sensor unit 4 is a device that is suitably applicable as a sensor that detects contact of a distal end portion of a robot arm unit to an external object. The tactile sensor unit 4 includes, for example, as illustrated in FIG. 19 and FIG. 20, a compound-eye imaging unit 10, a projecting unit 90, an elastic layer 30, and a controller 50.

The projecting unit 90 projects a fixed pattern image as a marker in an imaging region of the compound-eye imaging unit 10. The projecting unit 90 includes, for example, as illustrated in FIG. 19 and FIG. 20, a plurality of structured light sources 91 and a mark-less screen layer 92.

For example, each of the plurality of structured light sources 91 is disposed on the flexible sheet 11 and between corresponding two compound-eye imaging devices 12 adjacent to each other. For example, each structured light source 91 emits fixed pattern image light in a visible range toward the mark-less screen layer 92 provided in the imaging region of the compound-eye imaging unit 10. For example, the mark-less screen layer 92 is provided inside of the elastic layer 30 or on the surface of the elastic layer 30. The mark-less screen layer 92 includes, for example, a white silicone rubber layer.

In a case where the mark-less screen layer 92 includes a white sheet, each structured light source 91 includes, for example, a light emitting diode that emits light having a color that stands out on the white sheet (for example, red), and a patterned light blocking film provided on a light exiting surface of this light emitting diode. A pattern image obtained by reversing the pattern of the light blocking film is projected onto the mark-less screen layer 92.

The projecting unit 90 further includes, for example, as illustrated in FIG. 20, a driver 93 that drives each structured light source 91, and an FPC 94 that electrically couples each of the plurality of structured light sources 91 and the driver 93 to each other. For example, as illustrated in FIG. 20, the driver 93 and the FPC 94 are disposed on the flexible sheet 11. The driver 93 drives each structured light source 91 via the FPC 94.

### (Effects)

In this embodiment, the mark-less screen layer 92 provided inside of the elastic layer 30 or on the surface of the elastic layer 30, and the plurality of structured light sources 91 that projects the fixed pattern image as the marker onto the mark-less screen layer 92 are provided. In this manner, there is no need to provide the marker layer 40 or 41, and hence the tactile sensor unit 4 is easily manufactured. Further, there is no need to replace members along with the deterioration of the marker layer 40, and hence the maintainability is excellent.

### 7. Modification Example of First Embodiment

In the above-described first embodiment, each light emitting device 21 has emitted light of a single color. However, in the above-described first embodiment, the plurality of light emitting devices 21 may include, for example, as illustrated in FIG. 21 and FIG. 22, a plurality of light emitting devices 21r that emits red light, a plurality of light emitting devices 21g that emits green light, and a plurality of light emitting devices 21b that emits blue light. At this time, the marker layer 40 may include, for example, as illustrated in FIG. 21, a marker layer 40r that efficiently reflects the red light in a region to be illuminated by the red light emitted from the light emitting device 21r. Further, the marker layer 40 may include, for example, as illustrated in FIG. 21, a marker layer 40b that efficiently reflects the blue light in a region to be illuminated by the blue light emitted from the light emitting device 21b. With the marker layer 40 being illuminated by light having a plurality of wavelength bands as described above, it is possible to facilitate detection of displacement of each location of the marker layer 40.

### 8. Application Example

Next, a robot apparatus 100 in which any of the tactile sensor units 1 to 4 is provided in a distal end portion of a robot arm unit 120 is described. FIG. 23 illustrates an example of a perspective configuration of the robot apparatus 100. The robot apparatus 100 includes, for example, as illustrated in FIG. 23, a main body 110, robot arm units 120, a movement mechanism 130, a sensor 140, and two tactile sensor units 1 to 4.

The main body 110 is, for example, a center part which includes a power section and a controller of the robot apparatus 100, and to which each section of the robot apparatus 100 is to be mounted. The controller controls the two robot arm units 120, the movement mechanism 130, the sensor 140, and the two tactile sensor units 1 provided in the robot apparatus 100. The main body 110 may have a shape resembling a human upper body including a head, a neck, and a body.

Each robot arm unit 120 is, for example, a multi-joint manipulator mounted to the main body 110. One robot arm unit 120 is, for example, mounted to a right shoulder of the main body 110 resembling the human upper body. Another robot arm unit 120 is, for example, mounted to a left shoulder of the main body 110 resembling the human upper body. Any of the tactile sensor units 1 to 4 is mounted to a surface of a distal end portion (fingertip of a hand unit) of each robot arm unit 120.

The movement mechanism 130 is, for example, a part provided on a lower portion of the main body 110 and is responsible for movement of the robot apparatus 100. The movement mechanism 130 may be a two-wheeled or four-wheeled movement unit, or may be a two-legged or four-legged movement unit. Moreover, the movement mechanism 130 may be a hover-type, a propeller-type, or an endless-track-type movement unit.

The sensor 140 is, for example, a sensor that is provided on the main body 110 or the like to detect (sense) information regarding an environment (external environment) around the robot apparatus 100 in a non-contact manner. The sensor 140 outputs sensor data obtained through the detection (sensing). The sensor 140 is, for example, an imaging unit such as a stereo camera, a monocular camera, a color camera, an infrared camera, or a polarization camera. It is to be noted that the sensor 140 may be an environment sensor for use in detecting a weather or a meteorological phenomenon, a microphone that detects voice, or a depth sensor such as an ultrasonic sensor, a time of flight (ToF) sensor, or a light detection and ranging (LiDAR) sensor. The sensor 140 may be a position sensor such as a global navigation satellite system (GNSS) sensor.

In this application example, a part of functions of the tactile sensor units 1 to 4 may be provided in the controller of the main body 110. For example, as illustrated in FIG. 24, in each of the tactile sensor units 1 to 4, the marker detector 13b, the marker data buffer 13c, and the 3D vector generator 13d may be provided in the controller of the main body 110. At this time, each of the tactile sensor units 1 to 4 may include a data output section 13f that outputs data generated by the image integrator 13a to the main body 110. Further, the main body 110 may include a data input section 13g that receives the data output from each of the tactile sensor units 1 to 4, and a data processor 13h that processes the data generated by the 3D vector generator 13d. In such a case, it is possible to perform processing having an enormous amount of operation by the controller of the main body 110.

The present disclosure has been described above with reference to the embodiments, the modification examples, and the application example, but the present disclosure is not limited to the embodiments and the like, and is modifiable in a variety of ways. It is to be noted that the effects described herein are merely examples. The effects of the present disclosure are not limited to the effects described herein. The present disclosure may have effects other than the effects described herein.

Further, for example, the present disclosure may take the following configurations.

(1)

A contact sensor unit including:
a compound-eye imaging unit in which a plurality of compound-eye imaging devices is two-dimensionally disposed on a flexible sheet;
an illuminating unit that illuminates an imaging region of the compound-eye imaging unit; and
an elastic layer in which a marker is formed in the imaging region.
   (2)

The contact sensor unit according to (1), in which each of the compound-eye imaging devices includes a compound eye camera including a plurality of microlenses and one image sensor provided to correspond to the plurality of microlenses.

(3)

The contact sensor unit according to (1), in which each of the compound-eye imaging devices includes a plurality of facet cameras each including one microlens and one image sensor provided to correspond to the one microlens.

(4)

The contact sensor unit according to (1), in which each of the compound-eye imaging devices includes a plurality of facet pixels each including one microlens and one photodiode provided to correspond to the one microlens.

(5)

The contact sensor unit according to any one of (1) to (4), in which the illuminating unit is disposed on the flexible sheet and between corresponding two of the compound-eye imaging devices adjacent to each other.

(6)

The contact sensor unit according to any one of (1) to (4), in which
the marker contains a fluorescent material,
the illuminating unit is configured to emit excitation light that excites the fluorescent material, and
the contact sensor unit further includes a filter layer that covers a light receiving surface of each of the compound-eye imaging devices, and selectively transmits fluorescent light emitted from the fluorescent material.
   (7)

The contact sensor unit according to (6), in which
the flexible sheet includes a light guide layer that guides light emitted from the illuminating unit, and
the contact sensor unit further includes a light scattering layer in contact with a region of a surface of the flexible sheet, the region being between corresponding two of the compound-eye imaging devices adjacent to each other.
   (8)

The contact sensor unit according to (5), in which
the illuminating unit includes a plurality of first illuminating units that emits red light, a plurality of second illuminating units that emits green light, and a plurality of third illuminating units that emits blue light, and
the plurality of first illuminating units, the plurality of second illuminating units, and the plurality of third illuminating units are repeatedly disposed in order on the flexible sheet in a first direction and a second direction intersecting with the first direction.
   (9)

The contact sensor unit according to any one of (1) to (8), in which the elastic layer has a flexibility that is partially different.

(10)

The contact sensor unit according to any one of (1) to (8), in which
the elastic layer includes:
a cover layer provided on a surface to which an external object is to be brought into contact, the cover layer having a relatively high wear resistance as compared with another portion of the elastic layer; and
a soft layer provided in contact with a back surface of the cover layer, the soft layer including a material having a flexibility higher than a flexibility of the cover layer, and
the marker is formed in the soft layer.
   (11)

The contact sensor unit according to any one of (1) to (8), in which
the elastic layer includes:
a first elastic layer provided on a surface to which an external object is to be brought into contact, the first elastic layer having a relatively high flexibility as compared with another portion of the elastic layer; and
a second elastic layer provided in contact with a back surface of the first elastic layer, the second elastic layer having a flexibility lower than a flexibility of the first elastic layer, and
the marker is formed in both of the first elastic layer and the second elastic layer.
   (12)

The contact sensor unit according to any one of (1) to (11), in which the elastic layer has unevenness on a surface to which an external object is to be brought into contact.

(13)

The contact sensor unit according to any one of (1) to (11), further including a protruding portion having a hardness higher than a hardness of the elastic layer, the protruding portion being provided on a surface of the elastic layer to which an external object is to be brought into contact.

(14)

A contact sensor unit including:
a compound-eye imaging unit in which a plurality of compound-eye imaging devices is two-dimensionally disposed on a flexible sheet;
an elastic layer formed in an imaging region of the compound-eye imaging unit;
a mark-less screen layer provided inside of the elastic layer or on a surface of the elastic layer; and
a projecting unit that projects a fixed pattern image as a marker onto the mark-less screen layer.
   (15)

A contact sensor module including:
a contact sensor unit; and
a signal processing unit, in which
the contact sensor unit includes:
a compound-eye imaging unit in which a plurality of compound-eye imaging devices is two-dimensionally disposed on a flexible sheet;
an illuminating unit that illuminates an imaging region of the compound-eye imaging unit;
an elastic layer in which a marker is formed in the imaging region; and
an output section that outputs a detection signal obtained from each of the compound-eye imaging devices as compound-eye image data to the signal processor, and
the signal processing unit is configured to generate surface shape data of the elastic layer by processing the compound-eye image data inputted from the contact sensor unit.
   (16)

The contact sensor module according to (15), in which the signal processing unit is configured to generate pressure vector data about a pressure applied to the elastic layer by processing the compound-eye image data inputted from the contact sensor unit.

(17)

A contact sensor module including:
a contact sensor unit; and
a signal processing unit, in which
the contact sensor unit includes:
a compound-eye imaging unit in which a plurality of compound-eye imaging devices is two-dimensionally disposed on a flexible sheet;
an elastic layer formed in an imaging region of the compound-eye imaging unit;
a mark-less screen layer provided inside of the elastic layer or on a surface of the elastic layer;
a projecting unit that projects a fixed pattern image as a marker onto the mark-less screen layer; and
an output section that outputs a detection signal obtained from each of the compound-eye imaging devices as compound-eye image data to the signal processor, and
the signal processing unit is configured to generate surface shape data of the mark-less screen layer by processing the compound-eye image data inputted from the contact sensor unit.
   (18)

A robot arm unit including:
a hand unit;
an arm unit coupled to the hand unit, the arm unit including a wrist joint and an elbow joint; and
a contact sensor unit mounted to a fingertip of the hand unit, in which
the contact sensor unit includes:
a compound-eye imaging unit in which a plurality of compound-eye imaging devices is two-dimensionally disposed on a flexible sheet;
an illuminating unit that illuminates an imaging region of the compound-eye imaging unit; and
an elastic layer in which a marker is formed in the imaging region, and
the flexible sheet is attached to a surface of the fingertip.
   (19)

A robot arm unit including:
a hand unit;
an arm unit coupled to the hand unit, the arm unit including a wrist joint and an elbow joint; and
a contact sensor unit mounted to a fingertip of the hand unit, in which
the contact sensor unit includes:
a compound-eye imaging unit in which a plurality of compound-eye imaging devices is two-dimensionally disposed on a flexible sheet;
an elastic layer formed in an imaging region of the compound-eye imaging unit;
a mark-less screen layer provided inside of the elastic layer or on a surface of the elastic layer; and
a projecting unit that projects a fixed pattern image as a marker onto the mark-less screen layer, and
the flexible sheet is attached to a surface of the fingertip.

In the tactile sensor unit according to each of the first and second embodiments of the present disclosure, the tactile sensor module according to each of the third and fourth embodiments of the present disclosure, and the robot arm unit according to each of the fifth and sixth embodiments of the present disclosure, the plurality of compound-eye imaging devices is two-dimensionally disposed on the flexible sheet. This allows the tactile sensor unit to be mounted along the surface of the fingertip of the robot arm unit, and hence it is possible to avoid increasing the size of the hand unit of the robot arm unit due to the mounting of the tactile sensor unit. As a result, it is possible to achieve downsizing of the tactile sensor unit, the tactile sensor module, and the robot arm unit.

The present application claims the benefit of Japanese Priority Patent Application JP2021-196251 filed with the Japan Patent Office on Dec. 2, 2021, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A contact sensor unit, comprising:
a compound-eye imaging unit in which a plurality of compound-eye imaging devices is two-dimensionally disposed on a flexible sheet;
an illuminating unit that illuminates an imaging region of the compound-eye imaging unit; and
a deformation layer in which a marker is formed in the imaging region.

2. The contact sensor unit according to claim 1, wherein each of the compound-eye imaging devices comprises a compound eye camera including a plurality of microlenses and one image sensor provided to correspond to the plurality of microlenses.

3. The contact sensor unit according to claim 1, wherein each of the compound-eye imaging devices comprises a plurality of facet cameras each including one microlens and one image sensor provided to correspond to the one microlens.

4. The contact sensor unit according to claim 1, wherein each of the compound-eye imaging devices comprises a plurality of facet pixels each including one microlens and one photodiode provided to correspond to the one microlens.

5. The contact sensor unit according to claim 1, wherein the illuminating unit includes a plurality of light emitting devices each disposed on the flexible sheet and between corresponding two of the compound-eye imaging devices adjacent to each other.

6. The contact sensor unit according to claim 1, wherein the marker contains a fluorescent material,
the illuminating unit is configured to emit excitation light that excites the fluorescent material, and
the contact sensor unit further comprises a filter layer that covers a light receiving surface of each of the compound-eye imaging devices, and selectively transmits fluorescent light emitted from the fluorescent material.

7. The contact sensor unit according to claim 6, further comprising:
a flexible light guide layer that guides light emitted from the illuminating unit; and
a scattering layer in contact with a location of a surface of the flexible light guide layer, the location being opposed to a region between corresponding two of the compound-eye imaging devices adjacent to each other.

8. The contact sensor unit according to claim 5, wherein the plurality of light emitting devices includes a plurality of first light emitting devices that emits red light, a plurality of second light emitting devices that emits green light, and a plurality of third light emitting devices that emits blue light.

9. The contact sensor unit according to claim 1, wherein the deformation layer has a flexibility that is partially different.

10. The contact sensor unit according to claim 1, wherein
the deformation layer includes:
a cover layer provided on a surface to which an external object is to be brought into contact, the cover layer having a relatively high wear resistance as compared with another portion of the deformation layer; and
a soft layer provided in contact with a back surface of the cover layer, the soft layer including a material having a flexibility higher than a flexibility of the cover layer, and
the marker is formed in the soft layer.

11. The contact sensor unit according to claim 1, wherein
the deformation layer includes:
a first deformation layer provided on a surface to which an external object is to be brought into contact, the first deformation layer having a relatively high flexibility as compared with another portion of the deformation layer; and
a second elastic layer provided in contact with a back surface of the first deformation layer, the second elastic layer having a flexibility lower than a flexibility of the first deformation layer, and
the marker is formed in both of the first deformation layer and the second deformation layer.

12. The contact sensor unit according to claim 1, wherein the deformation layer has unevenness on a surface to which an external object is to be brought into contact.

13. The contact sensor unit according to claim 1,
wherein the deformation layer further includes a protruding portion having a relatively high hardness as compared with another portion of the deformation layer, the protruding portion being provided on a surface of the deformation layer to which an external object is to be brought into contact.

14. A contact sensor unit, comprising:
a compound-eye imaging unit in which a plurality of compound-eye imaging devices is two-dimensionally disposed on a flexible sheet;
an elastic layer formed in an imaging region of the compound-eye imaging unit;
a mark-less screen layer provided inside of the elastic layer or on a surface of the elastic layer; and
a projecting unit that projects a fixed pattern image as a marker onto the mark-less screen layer.

15. A contact sensor module, comprising:
a contact sensor unit; and
a signal processing unit, wherein
the contact sensor unit includes:
a compound-eye imaging unit in which a plurality of compound-eye imaging devices is two-dimensionally disposed on a flexible sheet;
an illuminating unit that illuminates an imaging region of the compound-eye imaging unit;
an elastic layer in which a marker is formed in the imaging region; and
an output section that outputs a detection signal obtained from each of the compound-eye imaging devices as compound-eye image data to the signal processing unit, and
the signal processing unit is configured to generate surface shape data of the elastic layer by processing the compound-eye image data inputted from the contact sensor unit.

16. The contact sensor module according to claim 15, wherein the signal processing unit is configured to generate pressure vector data about a pressure applied to the elastic layer by processing the compound-eye image data inputted from the contact sensor unit.

17. A contact sensor module, comprising:
a contact sensor unit; and
a signal processing unit, wherein
the contact sensor unit includes:
a compound-eye imaging unit in which a plurality of compound-eye imaging devices is two-dimensionally disposed on a flexible sheet;
an elastic layer formed in an imaging region of the compound-eye imaging unit;
a mark-less screen layer provided inside of the elastic layer or on a surface of the elastic layer;
a projecting unit that projects a fixed pattern image as a marker onto the mark-less screen layer; and
an output section that outputs a detection signal obtained from each of the compound-eye imaging devices as compound-eye image data to the signal processing unit, and
the signal processing unit is configured to generate surface shape data of the mark-less screen layer by processing the compound-eye image data inputted from the contact sensor unit.

18. A robot arm unit, comprising:
a hand unit;
an arm unit coupled to the hand unit, the arm unit including a wrist joint and an elbow joint; and
a contact sensor unit mounted to a fingertip of the hand unit, wherein the contact sensor unit includes:
a compound-eye imaging unit in which a plurality of compound-eye imaging devices is two-dimensionally disposed on a flexible sheet;
an illuminating unit that illuminates an imaging region of the compound-eye imaging unit; and
an elastic layer in which a marker is formed in the imaging region, and the flexible sheet is attached to a surface of the fingertip.

19. A robot arm unit, comprising:
a hand unit;
an arm unit coupled to the hand unit, the arm unit including a wrist joint and an elbow joint; and
a contact sensor unit mounted to a fingertip of the hand unit, wherein
the contact sensor unit includes:
a compound-eye imaging unit in which a plurality of compound-eye imaging devices is two-dimensionally disposed on a flexible sheet;
an elastic layer formed in an imaging region of the compound-eye imaging unit;
a mark-less screen layer provided inside of the elastic layer or on a surface of the elastic layer; and
a projecting unit that projects a fixed pattern image as a marker onto the mark-less screen layer, and
the flexible sheet is attached to a surface of the fingertip.
